(19) United States
(12) Patent Application Publication
(10) Pub. No.: US 2022/0025684 A1
(43) Pub. Date: Jan. 27, 2022

(54) Surface Mounted Door Check Device

(71) Applicant: William Steven Kroll, Houston, TX (US)

(72) Inventor: William Steven Kroll, Houston, TX (US)

(21) Appl. No.: 17/492,581

(22) Filed: Oct. 2, 2021

Related U.S. Application Data
(66) Substitute for application No. 17/139,805, filed on Dec. 31, 2020, now abandoned.

(51) Int. Cl. E05C 17/36; E05C 17/22

(52) U.S. Cl. CPC E05C 17/36; E05C 17/22

(57) ABSTRACT

A surface-mounted device for controlling the swing/rotational motion of a hinged door/panel system. Said device controls the velocity of the door/panel's and provides check point(s) in the pathway of its motion. The device includes a non-pivoting carrier component to be fixed upon a hinged door/panel, a non-pivoting receiver component fastened to the adjacent and separate area which shares a common hinge(s)/axis with the movable door/panel and a flexible control arm component firmly attached at one end to the carrier. The flexible control arm is aligned with the receiver's through-body aperature by means of the carrier's fixed position on a movable hinged door/panel and provides control of the door/panel by means of passing into and through the aperature provisioned in the receiver in a linear manner to provide both speed and positional check control (motion detents) of the door's potential swing arc path. The speed control aspect of the device is accomplished by means of controlled frictional contact between the flexible control arm's component material(s) and the receiver's aperature and this effect is enhanced by means of the temporary physical deformation exhibited by the flexible control arm whilst it is undergoing loading stresses as it passes within the constriction of the receiver's aperature geometry, its component materials and the energized spherical element acting upon the wide surface of the flexible control arm by limiting frictional contact between the flexible control arm and the receiver's aperature when the energized spherical element is not engaged with the flexible control arm's provisioned negative areas(s) and the attached door/panel is in motion. Maximum frictional force is delivered by the device when the spherical element engages a provisioned negative area on the flexible control arm, thus creating a check in the door/panel swing path. The device may be added/retrofitted to the surfaces of a pre-existing or new hinged door/panel system without significant design or structural modifications of said hinged door/panel systems and their associated components.

### BACKGROUND OF THE INVENTION

Various types and design of door check and swing control devices and systems of hinged panel systems have been designed for the safety and convenience of the user. Such systems provide for various hold-point positions along the path of a hinge's movement and those panels attached to them. For example, it is common for vehicle doors to be supplanted with door check control systems allowing the door to stop at various points along the potential swing path of the door. It is desirable for the door to maintain a partially or fully open position to oppose natural weather conditions like wind loading as well as inclined vehicle positions for the safe ingress and egress of the vehicle's user. This same concept has been extended, albeit, for use in various foldable forms such as luggage, tool/storage boxes, portable devices, space dividers etc. wherein it is desirable to inhibit the swing of the hinged system in one or more predetermined positions.

In most automotive door check systems, the components are, at least partially, built into the bodywork of the vehicle. There are, however, instances in the automotive realm wherein a built-in door check system either isn't fitted by the carmaker and/or having a built-in door check is a hindrance. This situation would be exemplified for vehicles with doors that are designed to be removed from the vehicle by the user with the minimum of time and complexity.

U.S. Pat. No. 1,646,580 discloses a door check system that was designed to displace the door stop strap that is still found in some vehicles with doors designed to be easily removed by the user. Said device uses a primarily flat strap which is designed to maintain a relatively straight line when in use preventing buckling. This system, however, does not lend itself to ease of door removal and is limited to a single door restraint position.

U.S. Pat. No. 6,948,214 discloses a removable device for holding an automotive door in the open position. Designed primarily for use on a vehicle during the assembly process, this device is designed to be placed onto the vehicle's door hinge pin, it is made of a flexible material such as steel. It is limited by its provisioning only a single door position as well as the necessity to attach the device each instance that the user wants to keep the vehicle door in the fully open position and the device must be removed in order to close the door.

U.S. Pat. No. 6,901,630 discloses a door check device in which a formed arm allows for multiple stops in the door's swing path by means of spring energized rollers which press upon the formed planes of the formed pivoting arm. Its dual roller design effectively maintains alignment of the pivoting formed arm relative to the vehicle's body, however, checks in the door swing motion are limited to those provisioned in the formed arm. This limitation requires additional tool forming of the door check arm for doors of different styles and weights.

U.S. Pat. No. 6,711,778 discloses a door check device in which a substantially flat bar controls the door's swing by way of at least one spring energized roller making contact with the shorter edge. This short edge has predetermined contours upon which the sprung roller rides, providing various levels of resistance to the swing of the door. The relatively small contact area between the roller and the bar forces the utilization of a high spring rate which increases wear on the components and requires high precision alignment of the system's components relative to each other, which in turn, increases the cost to manufacture.

It is therefore desirable to offer a door check system which overcomes the many shortcomings of previous designs. Because the majority of vehicular door check applications deal with doors of various weights and sizes, most door check designs are bespoke for their intended application and, therefore, require specialized tooling, forging and engineering to fulfill their mission effectively. My new design overcomes many of those stated limitations of earlier designs and is a more universal design for a wide range of doors.

### BRIEF SUMMARY OF THE INVENTION

My Surface Mounted Door Check Device provides an economical, lightweight and adaptable means of adding intermediate door check stops to a hinged door/panel's swing path. This novel design, once installed, allows for tool-free separation of the door from its adjacent frame/body receiver connection. The design utilizes engineered materials to provide frictional control as a means of controlling the velocity of the door/panel's swing motion. The intermediate door check stop(s) are provisioned as negative areas within the flexible control arm for the requirements of the application. The system is adaptable to accommodate for the weight and size of a wide range of doors/panels.

Previous door check systems and devices are relatively complex mechanical devices. My new design has only three distinct components, the carrier, the flexible control arm and the receiver, all of which are surface mounted.

My new door check design allows the system to be installed on the surface of the inboard side of an outward swinging door. Because of the unique component design, this can be accomplished on most vehicles with removable doors without modifying the bodywork or chassis.

Previous and current door check systems often require lubrication. Lubricants often attract dust, dirt and other particulates which are detrimental to the door check device and its operational characteristics. This new design, optionally, uses a single self-lubricating plain bushing to reduce friction between the energized spherical element and the compression spring housed within the receiver when required by the application.

Many other designs of door check devices utilize a a pivoting rigid component to connect a door component to an adjacent frame area/bodywork component of the door check system. My new design requires no pivots instead utilizing a flexible control arm component to make the door to frame/bodywork connection.

The flexible control arm component of my new design may be provisioned with negative spaces/areas(s) which, by their size, shape and spacing, provides points of control for the intermediate swing check(s). The material properties of the flexible control arm, such as thickness, width, surface hardness, texture and stiffness contribute to control of the velocity of the door swing motion.

My new door check system is provisioned with an energized spherical element, which interacts with the negative space(s) provisioned within the flexible control arm. It is energized by the use of a compression spring. The energized spherical element, the compression spring and the optional plain bearing are housed within the receiver component.

The flexible control arm, spherical element and compression spring may be replaced with ease for other like-kind parts while being of different engineering/material characteristics and/or compressive force to accommodate for different static and dynamic loading and the varying weight, mass and size of the panels/doors to be controlled.

### A BRIEF DESCRIPTION OF THE DRAWINGS

FIG. 1 Is a perspective view of the preferred embodiment of the invention as it may be applied to a door 11a and chassis 11.

FIG. 2 is a cross-section schematic top view of the receiver body 1, as well as, the flexible control arm 4, a spherical element 12, a compression spring 5, a flanged bushing 8, receiver covers 2 and fasteners 3.

FIG. 3 is an exploded, isometric view of the receiver.

FIG. 4 Is a top view of the invention as it may be applied to a door 11a, chassis 11 and hinge 9 that are in a primarily closed position.

FIG. 5 illustrates the same parts as described in FIG. 4 and the door 11a, by way of rotation upon the hinge 9 is now seen in at least a partially open position.

FIG. 6 Illustrates examples of two possible conditional positional states which are labeled as drawings p1 and p2 of the components contained within the receiver 1 when they may interact with the linear motion of the flexible control arm 4 and its provisioned negative areas 4a.

FIG. 7 Is an isometric view of the underside, that partial portion of the carrier 6 which may make contact with a pre-existing surface(s) and showing features 6a and 6d which are negative spaces provisioned within the carrier's 6 body associated bracket 14 further lessens the need for the use of an optional door limiting stop block 15 as seen in FIG. 9

FIG. 8 Shows five possible configuration examples of negative spaces which may be provisioned for the flexible control arm 4. As labeled, negative areas illustrated are door 11a swing check points for the invention. Said examples are illustrated and labeled as v1, v2, v3, v4 and v5.

FIG. 9 Is an isometric view of the invention in an unmounted state.

### DESCRIPTION OF THE PREFERRED EMBODIMENT

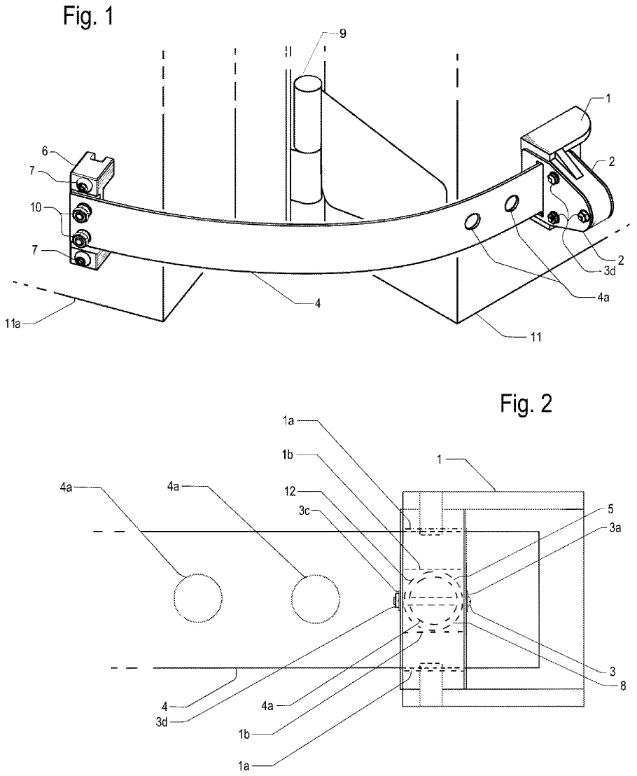

FIG. 1 Is a perspective view of the preferred embodiment of the invention as it may be applied to a door 11a and chassis 11, which is shown in a partially open position as viewed from the interior of a vehicle. The door 11a rotates about a fixed axis upon a pre-existing hinge assembly 9, the axis of which is ostensibly parallel with the nearest edges of the pre-existing chassis 11 and the pre-existing door 11a.

In this embodiment of the invention, the flexible control arm 4 is fixed to the carrier 6 with fasteners 10, which is in turn, fixed to a door 11a with fasteners 7 and bridges across the door 11a, hinge 9 and into the receiver 1, which is fixed to the chassis 11. The installed position of the invention is reversible, wherein the receiver body 1 may be fixed to a door 11a and the carrier 6 with the fixedly attached flexible control arm 4 which may be attached to the chassis 11 without a loss of functionality.

Check points for control of the door 11a, to which the invention may be installed upon, the swing of which, is controlled, at least in part, via the negative spaces 4a as provisioned within the body of the flexible control arm 4. The size, shape and spacing of these negative spaces 4a may be determined by the requirements of the specific application as well as the user's preferences.

The receiver body 1 is enclosed with two receiver covers 2 which are attached to opposing sides of the receiver's body 1 with fastener parts labeled 3, 3a and 3b. The fastening(s) may be of any suitable type or nature to address the needs of the application and/or the ease of manufacturability of the invention and all that entails.

FIG. 2 is a cross-section schematic top view of the receiver body 1, as well as, the flexible control arm 4, a spherical element 12, a compression spring 5, a flanged bushing 8, receiver covers 2 and fasteners 3. In this view the negative space feature 4a of the flexible control arm 4 is aligned with the energized spherical element 12 which is located at this point of its travel through the receiver's 1 negative area 1a, thus creating a check, which may also be described as a point of higher than normal friction within the system's operational parameters. Located within the receiver's 1 negative area labeled 1b are components nearest the viewer in descending vertical order, the compression spring 5, the flanged bushing 8, the spherical element 12 and the flexible control arm 4.

The flanged bushing 8 which may have a self-lubricating property, is placed between the spherical element 12 and the compression spring 5 acts and may act as an anti-friction bearing facilitating potential, and desirous property of rotational motion of the spherical element 12 as the flexible control arm 4 may pass in a linear direction beneath its surface. Said component group is oriented in a perpendicular geometry in relation to one of the two widest faces of the flexible control arm 4. This arrangement may place the energized spherical element 12 in alignment and in forced contact with the potential travel pathway of the flexible control arm 4 and, in particular, with its provisioned negative spaces 4a. The flexible control arm 4 is held in alignment with the aforementioned components within a boundary 1a formed as a negative spatial feature within the carrier body 1 and primarily and generally rectangularly shaped through-slots 2a which are provisioned in the receiver covers 2.

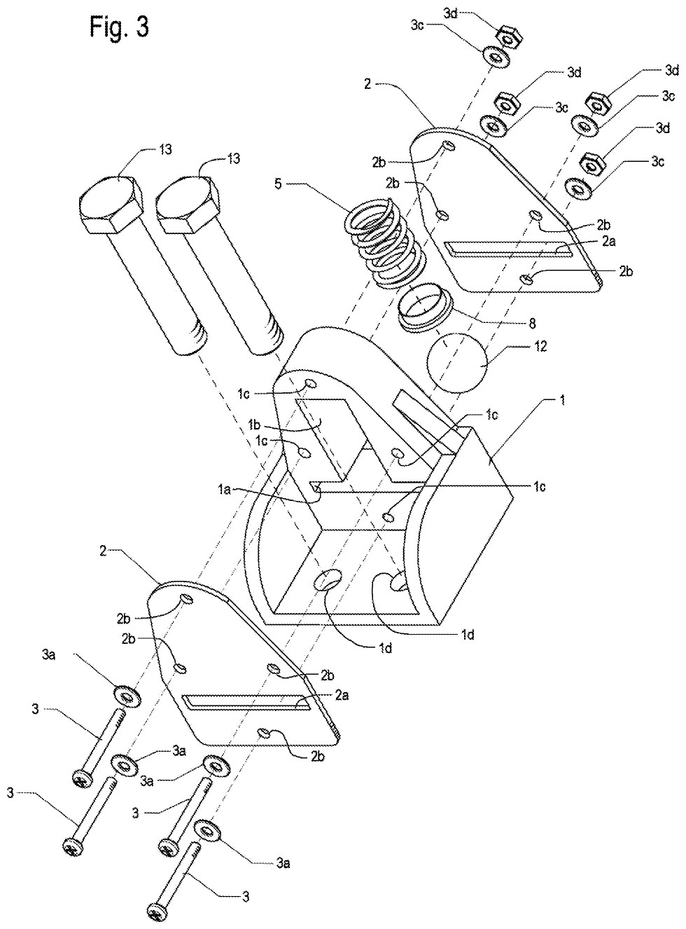

FIG. 3 is an exploded, isometric view of the receiver body 1 exhibiting a cavity defined by, and as seen in this drawing viewpoint as, a primarily vertical negative section which is marked as area 1b and of which, when assembled, partially encloses the spherical element 12 which is located, as illustrated, at the lowest point within this area, the flanged bushing 8 rests immediately both above and upon the spherical element 12 and at the top of this described area is the compression spring 5. The outer, non-flanged diameter of the bushing 8 is designed so as to be inserted within the inner diameter of the compression spring 5 with the lowest portion of the compression spring 8 retained by the top surface of flanged section of said bushing 8.

The lower section of negative area 1b of the receiver 1 is shown as being of a primarily horizontal area in appearance and is marked as area 1a. Negative area 1a will be occupied primarily, when assembled, by the flexible control arm 4. The negative area 1a, as aforementioned, extends through the receiver body 1.

Enclosing the receiver body 1 are two receiver covers 2 which may be provisioned with thru-holes 2b which align with and receiver 1 provisioned thru-holes 1c in the receiver body 1. Alignment of the aforementioned negative spaces 2b and 1c facilitates the use of mechanical fastener components 3, 3a, 3b, 3c and 3d which pass through all three of these components, namely two of receiver covers 2 and one receiver body 1, to constrain and assist in containing the compression spring 5, the flanged bushing 8 and the spherical element 12 as an aligned assembly within the receiver body 1. The two receiver covers 2 are also provisioned with negative through-holes 2a which generally align with negative area 1a in the receiver body.

The receiver body 1 is may also be provisioned with through-holes 1d which may allow mechanical fasteners 13 to attach the receiver body 1 to a chassis, of any manner, as illustrated in FIG. 1. The design of, or the provisioning of, said through-holes is dependent on the particular application and/or facilitating the ease of manufacture of the invention and its associated componentry.

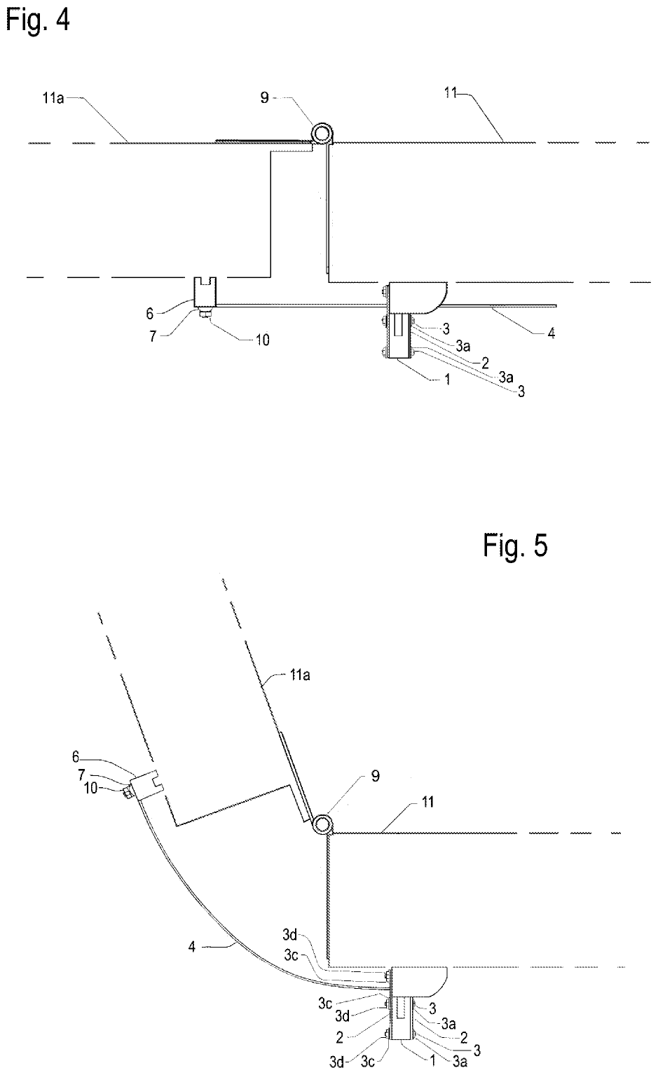

FIG. 4 Is a top view of the invention as it may be applied to a door 11a, chassis 11 and hinge 9 that are in a primarily closed position. We see, herein, the carrier 6 and the flexible control arm 4 which may be fixedly attached by means of mechanical fasteners 10 and the carrier body 6 is affixed to the pre-existing door 11a with fasteners 7. When said door 11a and chassis 11 are in this closed position it should be noted that the flexible control arm 4 is primarily straight in shape and in alignment with negative spaces 2a as provisioned in the carrier covers 2 and also with 1a as a negative space within the receiver body 1.

FIG. 5 illustrates the same parts as described in FIG. 4 and the door 11a, by way of rotation upon the hinge 9 is now seen in at least a partially open position. It should be noted that the flexible control arm 4, which is fixedly attached to the carrier body 6, is now distorted into an arc shape by the rotation of the door 11a. Said rotation of the door 11a has increased the base distance between the carrier body 6 in relation to the receiver body 1 and the flexible control arm 4 which has been positioned into the receiver body 1 by means of the provisioned space 1a as seen in FIG. 3.

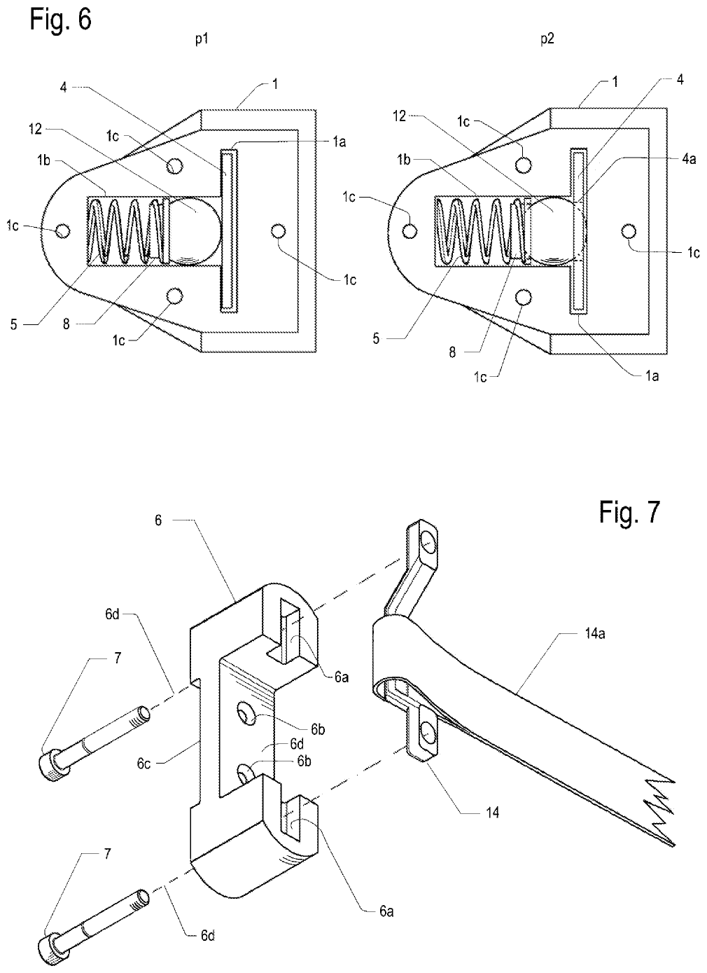

FIG. 6 Illustrates examples of two possible conditional positional states which are labeled as drawings p1 and p2 of the components contained within the receiver 1 when they may interact with the linear motion of the flexible control arm 4 and its provisioned negative areas 4a. Said linear motion is the result of a converted and conveyed rotational motion of the door 11a as it may be rotated on the hinges 9 in relation to the receiver 1 when said receiver 1 is, or may be, utilized as a stationary element in the invention being fixedly mounted to the chassis 11.

Both illustrations p1 and p2, show through-holes 1c, which may be provisioned wherein the use of mechanical fasteners 3, 3a, 3c and 3d may be desirable. The use of and/or style and nature of said fasteners is variable as to the application of the invention or its ease of manufacture.

In illustration p1 we see a cross-sectional view of the receiver body 1 and the flexible control arm 4 with the compression spring 5 in its most compressed state as the flexible control arm 4 is occupying negative space 1a in the receiver body 1 but has not yet reached a potential check position 4a as provisioned on the flexible control arm 4. In this positional state, the spherical element 12 is riding on the primary positive (non-negative) surface of the flexible control arm 4.

The second illustration of FIG. 6 is p2 which Is a cross-sectional view of the receiver body 1 and the flexible control arm 4 with the compression spring 5 in its most distended state. This new state of relationship between the aforementioned parts of the invention is also known as a check state and is the result of the flexible control arm 4 having travelled in a linear manner within negative space 1a and with the spherical element 12 having travelled vertically into a negative space 4a which may be provisioned on the flexible control arm 4 by means of the of the stored energy in the compression spring 5.

FIG. 7 Is an isometric view of the underside, that partial portion of the carrier 6 which may make contact with a pre-existing surface(s) and showing features 6a and 6d which are negative spaces provisioned within the carrier's 6 body. The spaces labeled 6a and 6d are designed so that may facilitate the integration with and incorporate the use of a pre-existing door limiting strap 14a and its pre-existing door limiting strap bracket 14 over which the carrier body 6 may be placed. In this feature 6a the fasteners 7 may secure both the carrier body 6 and the pre-existing door limiting strap bracket 14 to a door 11a as seen in FIG. 1. Door limiting straps 14a are common on vehicles which feature removable doors and it may be desirable to maintain the existing door limiting strap 14a as it often carries electrical wiring within. Maintaining the existing limiting door strap 14a and its associated bracket 14 further lessens the need for the use of an optional door limiting stop block 15 as seen in FIG. 9

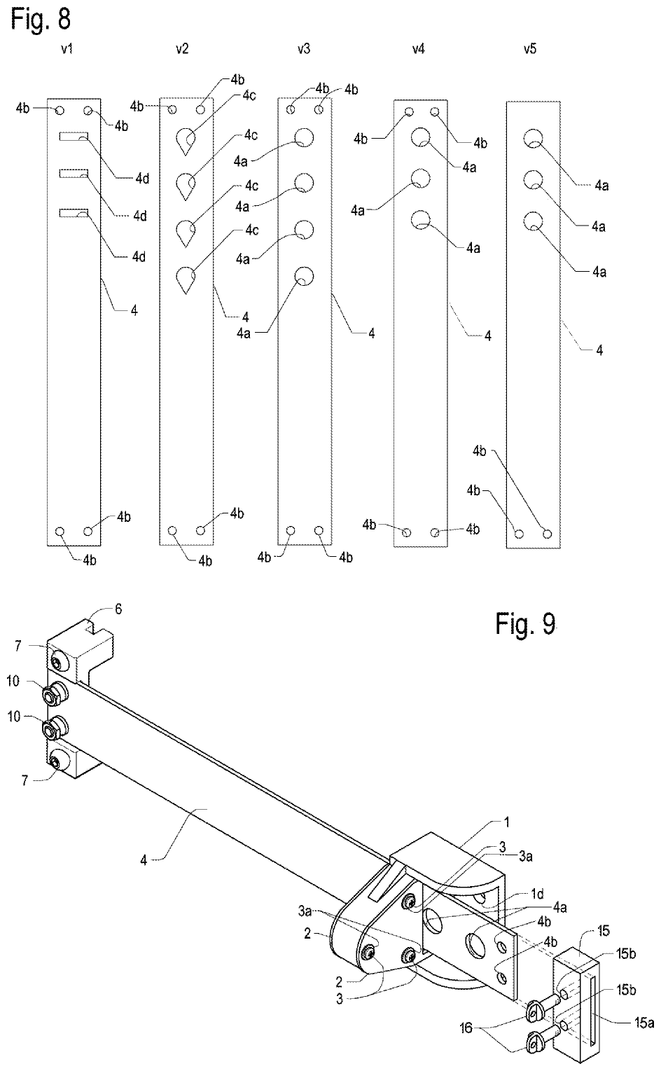

FIG. 8 Shows five possible configuration examples of negative spaces which may be provisioned for the flexible control arm 4. As labeled, negative areas illustrated are door 11a swing check points for the invention. Said examples are illustrated and labeled as v1, v2, v3, v4 and v5. as to the variable quantity, size and shape options for negative spaces which may, but are not limited, to be provisioned within the flexible control arm 4 body to enable possible door 11a swing check points. Also pictured are provisioned through-holes 4b which may be used as mounting points for connecting fasteners to required or optional components as a part of the invention and its particular application requirements. All of the negative spaces illustrated may vary in size in relation to the application and the components being provisioned for various applications of the invention.

Illustrated in drawing v1 are three negative check point location spaces 4b on the flexible control arm 4. These have a primarily rectangular form. You will also see four through-holes 4b for mechanical attachment.

In drawing v2 we see the flexible control arm 4 provisioned with four ovoid teardrop shaped negative areas 4c check point locations. You will also see four through-holes 4b for mechanical attachment.

Illustration v3 shows another variation with four spherical negative areas 4a check point locations. You will also see four through-holes 4b for mechanical attachment.

Drawing v4 shows three spherical negative spaces 4a check point locations. The number and size of negative spaces is variable and may be utilized in a manner that is befitting the application. You will also see four through-holes 4b for mechanical attachment.

In drawing v5 there are only two through-holes 4b on the flexible control arm 4 to illustrate that in some applications there is variability in the number (and size) of potential fasteners to be used in the invention, dependent on the needs of the particular application. In this instance, there is no requirement for the stop-block 15 assembly as seen in FIG. 9. There are three spherical negative spaces 4a check point locations on the flexible control arm 4.

FIG. 9 Is an isometric view of the invention in an unmounted state. It should be noted that in this variation, an optional stop-block 15 is shown. This optional element is useful when the vehicle lacks an existing and/or installed door limiting strap 14a as seen in FIG. 7. The stop block assembly 15 features a through-slot 15a to accept entry of the flexible control arm 4. The stop-block 15 also features tool-free fasteners 16 of any design. In practical application, the flexible control arm 4 passes through receiver cover(s) 2 by way of provisioned through areas 2a, the receiver 1 in a linear manner by way of area 1a, and its attached and finally into the body of the stop-block's provisioned through-slot 15a where said component may be provisioned with through-holes 15b which may be brought into alignment with the two through-holes 4b on the flexible control arm 4. The tool-free fasteners 16 may be of any practical and applicable nature may then be inserted into and through the provisioned through-holes 15b located on the stop-block 15 as well as the through-holes 4b located on the flexible control arm 4 thus fixedly retaining the stop-block 15 in a pre-determined area upon the flexible control arm 4.

What is claimed is:

1. The invention is characterized by the implementation of a flexible control arm with one or more negative spaces and a non-pivoting carrier body and a non-pivoting receiver body with at least one through body aperture and containing an energized spherical element within its body; for the control of a hinged two-panel assembly, a.k.a.; a door check device, for the control of one, either or both hinged panels, which share a common axis of potential rotation; and wherein the resultant action of said panels' rotational motion shall cause a linear motion of the flexible control arm as it's body passes through an aperture on and of the receiver assembly's body and wherein said motion shall exert a controlled frictional force(s) upon the flexible control arm's body as it mechanically contacts the receiver assembly's aperture; further additional controlled friction is exerted upon the flexible control arm at predetermined point(s) in the linear path of the flexible control arm as it travels through the aperture of the receiver assembly as its predetermined negative space(s) interact with the energized spherical element contained within the receiver assembly body; said frictional forces and mechanical interactions are the means of controlling the speed of the two-panel assembly's rotational motion and the predetermined positional checks of the hinged panel(s) as they travel through their radius of rotational swing motion pathway.

2. The flexible control arm as claimed in claim 1, having a body with a primarily rectilinear shape and having a length, width and thickness; and having a first body end and a second body end; the body of which is provisioned with one or more negative areas through the entire thickness of the flexible control arm body; said negative space(s) provisioned are fully contained within the boundaries of said body; and said negative spaces as described, are a means of controlling the flexible control arm's interaction with the energized spherical element as claimed in claim 1. and having, substantially effective alignment between the energized spherical element and said negative space(s) and aforementioned negative areas shall have, primarily, approximate corresponding shapes and sizes as they dimensionally and geometrically/spatially relate to the size and shape of the energized spherical element, the design of which shall enable a controlled frictional force to be exerted upon the arm at said areas; and wherein at least a portion of the energized spherical element travels into said negative space(s) of the flexible control arm when those elements of the invention may become aligned, at a primarily 90 degree angle of intersection; and said frictional force(s) produced by said interaction are a direct means for controlling the linear travel of the arm as it passes through the aperature of the receiver assembly which houses the energized spherical element.

3. The flexible control arm, as claimed in claim 2; being composed of a material(s) having a relatively high mechanical strength for the intended design load to be supported, a substantially high surface hardness for resistance to wear, scratching and galling; and possessing a flexibility suitable for the mass and weight of the hinged panels for which a particular variant is designed, it shall also have a thickness which is appropriate for the progressive arc to be imposed upon its body as the hinged panels are rotated upon their shared axis; and because the area spanned between those panels is variable, that distance being dependent on the relative positions of; the carrier body and the receiver assembly, as claimed in claim 1; said materials of which may possess the nature and characteristics of some of those commercially available sheet and plate goods available in the marketplace such as: high-pressure fiberglass laminates and similar variants such as those containing Kevlar as well as a range of carbon fiber composites with similar characteristics, which all have an engineered resilience and thus, a proclivity to maintain their original and primarily flat planar nature; that is, while and having been exposed to repeated external mechanical stresses; and without showing significant signs of deterioration of their material structure after many cycles of said imposed mechanical stresses.

4. The flexible control arm as claimed in claim 3. having a first body end which is rigidly attached to a non-pivoting carrier body as claimed in claim 1; that is, in turn, rigidly attached to the first panel of the two-panel hinged assembly as claimed in claim 1; said carrier body is oriented upon the first hinged panel so as to align and orient the longitudinal axis and thus, the second body end of the flexible control arm directly towards an open aperture of the receiver assembly body which is rigidly attached to the second hinged panel.

5. The second body end of the flexible control arm, as described and referenced in claim 4. is possessed of sufficient length that its body may pass into and through an open aperture of the non-pivoting receiver assembly's body; and said receiver body shall assist in orienting the flexible control arm, so that when the two hinged panels are in a closed position, and wherein their surfaces share a common plane, the two larger surfaces, comprised of the length and width of the flexible control arm, is in a primarily parallel oriented position in relation to that of the two hinged panels planar alignment whilst in the aforementioned closed position and the second body end of the flexible control arm, having been provisioned with sufficient length, as mounted via the carrier body, is spatially and directionally oriented so that it's second body end will substantially align with and pass through the open aperture that is provisioned within the receiver assembly body; which is fixedly attached to the second hinged panel and within which resides an energized spherical element which shall engage, in a substantially perpendicular direction, with the provisioned negative areas of the flexible control arm, so that when the two panels are rotated upon their shared axis, in a direction which is opposite to those hinged panel surfaces upon which the carrier body and the receiver body are fixedly attached, the flexible control arm, having been provisioned with sufficient length so that it's longitudinal body length surpasses the span distance between the carrier body and the receiver assembly, shall enable the receiver body assembly's energized spherical element to engage with the flexible control arm's prescribed negative areas, and so that when said engagement occurs said interaction is creating points of additional friction at said points of engagement along the flexible control arm's longitudinal axis so as to effectively control the rotational motion of the hinged panel assembly.

6. A flexible control arm as claimed in claim 5. wherein an end stop may be affixed mechanically and positioned at the second body end of the flexible control arm to effectively prevent an unwanted withdrawal of the control arm from the receiver assembly's aperature.

7. An end stop as described in claim 6. Which may be composed of a material(s) which have shock absorbing qualities.

8. An end stop as described in claim 7. whose mechanical fittings for affixing said end stop to the second end of the flexible control arm may be attached and removed without the use of a tool(s).

9. A flexible control arm as described in claim 1. Wherein the negative space(s) provisioned may be provisioned in a variety of possible sizes and shapes so as to accommodate the energized spherical element and therefore control the motion of the door in a desired and controlled manner.

10. A flexible control arm as described in claim 9. wherein the distance and/or position of the provisioned negative space(s) within the body is determined by the designer to accommodate and provide the desired operational characteristics for a particular application.

11. A receiver assembly as described in claim 1. whose body may be fabricated in one or more pieces and in a wide variety of methods and materials, the selection of which is designed to accommodate the loading, both dynamic and static, of its intended application.

12. A receiver assembly as described in claim 11. that possesses a hollow or enclosed area which spatially accommodates a spherical element and compression spring, of any nature, wherein said area is oriented in a substantially perpendicular geometric manner to the surface upon which the receiver assembly is fixedly attached as well as the flexible control arm's surface.

13. A receiver assembly as described in claim 12. which may be provisioned with mounting holes whose position on the body of the receiver may be designed to align with existing fasteners of a particular vehicle or other device.

14. A receiver assembly as described in claim 13. that possesses an aperature, whose area/space is parallel to the surface that the receiver assembly is affixed to, and has a design and dimension to accommodate the flexible control arm's second end profile and said aperature may be provisioned with materials and geometry to enhance the control of the flexible control arm.

15. A spherical element as described in claim 1. that may have a near perfect spherical geometric form or what may be best described as a barrel shape form as described in anti-friction bearing engineering literature, the composition of said spherical element may be of any suitable material(s) which accommodates the loading for which it is designed. Said materials may include, but are not limited to, metallic alloys, compression formed powdered metals, phenolics and plastics which may possess a lubricious nature.

16. In many envisioned applications of the invention, it may be desirable to allow free rotation of the spherical element as described in claim 15. and said rotational capability would be enhanced through the utilization of anti-friction materials, said materials being incorporated in either of the spherical element itself or by means of a separate anti-friction plain bearing which may be positioned between the spherical element and the compression spring within the receiver and thereby acting as a carrier for the spherical element and/or as a fitting upon the compression spring,

17. An anti-friction bearing as described in claim 16. which may have a geometric design form that is fitted to accommodate the geometry of one end form of the compression spring as well as the geometry of the spherical element being utilized and may be of a plain self-lubricating material or a more complex nature with one or more rotating elements.

18. A compression spring as described in claim 17. which may be of a commercially available or bespoke design whose size, material and potential energy capacity is determined in accordance with the application for which it is selected and/or designed.

19. A carrier body as described in claim 1. which may be affixed directly to one panel of the pre-existing two-piece hinged panel assembly and may possess a negative area on the side which faces the panel to which it may be attached and the design of which is formed and/or machined to accommodate a pre-existing door retention strap and its mechanical fitting(s).

20. A carrier body as described in claim 19. which has mounting holes that may be positioned to align with pre-existing fasteners on the panel to which it is to be fitted upon.

21. A carrier body as described in claim 20. which may have a prescribed negative area(s) formed or machined on its body surface which is oriented parallel to and opposite the pre-existing hinged panel surface to accommodate the first end of the flexible control arm and its mechanical fasteners.
